(19) United States
(12) Patent Application Publication
(10) Pub. No.: US 2002/0097298 A1
(43) Pub. Date: Jul. 25, 2002

(54) Electrical contacting apparatus in ink jet printer

(76) Inventor: Seuk-Jin Yun, Suwon-city (KR)

Correspondence Address: Robert E. Bushnell, Suite 300, 1522 K Street, N.W., Washington, DC, 20005-1202, US

(21) Appl. No.: 09/844,665

(22) Filed: Apr. 30, 2001

(30) Foreign Application Priority Data
Jan. 22, 2001 (KR) 01--3584

(51) Int. Cl. B41J 2/01

(52) U.S. Cl. 347/50

(57) ABSTRACT

An electrical contacting apparatus in an ink jet printer includes a plurality of spring elastic members corresponding to the contact portions of the ink cartridge. Each of the spring elastic members includes a contact portion which contacts a contact portion of the ink cartridge, a base having one end electrically connected to the printed circuit board, and a connection portion connected to the contact portion and the base for providing an elastic restoration force between the contact portion and the base. According to this structure, the contact resistance at the contact surface of a spring elastic member which contacts each of the contact portions of the ink cartridge is reduced, thereby improving the quality of printing.

### CLAIM OF PRIORITY

This application makes reference to, incorporates the same herein, and claims all benefits accruing under 35 U.S.C. §119 from my application entitled Apparatus For Electrical Contact Of Inkjet Printer filed with the Korean Industrial Property Office on Jan. 22, 2001 and there duly assigned Serial No. 2001/3584.

### BACKGROUND OF THE INVENTION

1. Field of the Invention

The present invention relates to an electrical contacting apparatus in an ink jet printer, and more particularly, to a contacting apparatus for electrical connection between an ink cartridge and a carrier.

2. Description of the Related Art

General ink jet printers are output apparatuses in which an ink cartridge installed in a carrier that sprays ink onto the surface of paper while moving horizontally, so that pictures or characters are printed.

This printing is performed by an ink cartridge, which is installed in a carrier, receiving an electrical signal from the main board of a computer and spraying ink. Here, an ink cartridge is electrically connected to a carrier in which an ink cartridge is to be installed.

### SUMMARY OF THE INVENTION

It is an object of the present invention to improve the quality of printing of ink-jet printers.

It is also an object of the present invention is to provide an electrical contacting apparatus for improving the quality of printing by reducing the contact resistance at the contact surface contacting the contact portions of an ink cartridge using a spring elastic member.

It is also an object of the present invention to have the spring elastic members form electrical contact with a printed circuit board and with contact portions of an ink cartridge.

It is further an object of the present invention to provide spring elastic members that provide constant contact force without affecting adjacent spring elastic members.

It is also an object of the present invention to provide spring elastic members that provide constant contact force to the contact portions of an ink cartridge even though the spring elastic members contacts the contact portions of the ink cartridge for a long period of time.

To achieve the above objects, the present invention provides an electrical contacting apparatus in an ink jet printer, for contacting the contact portions of an ink cartridge with the contact portions of a printed circuit board installed on a carrier in order to electrically connect the ink cartridge to the carrier on which the ink cartridge is mounted, the apparatus including a plurality of spring elastic members corresponding to the contact portions of the ink cartridge. In this apparatus, each of the spring elastic members includes a contact portion which contacts a contact portion of the ink cartridge; a base having one end electrically connected to the printed circuit board; and a connection portion connected to the contact portion and the base for providing an elastic restoration force between the contact portion and the base.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of an ink cartridge and a carrier for an ink jet printer including an existing electrical contacting apparatus;

FIG. 2 is a cross-sectional view illustrating the contact portions of the ink cartridge and the contact portions of the flexible printed circuit board (FPCB) of FIG. 1 in greater detail;

FIG. 3 is an exploded perspective view illustrating the major parts of an ink jet printer including an electrical contacting apparatus according to the present invention; and

FIG. 4 is a cross-sectional view of the electrical contacting apparatus of the ink jet printer of FIG. 3.

### DETAILED DESCRIPTION OF THE INVENTION

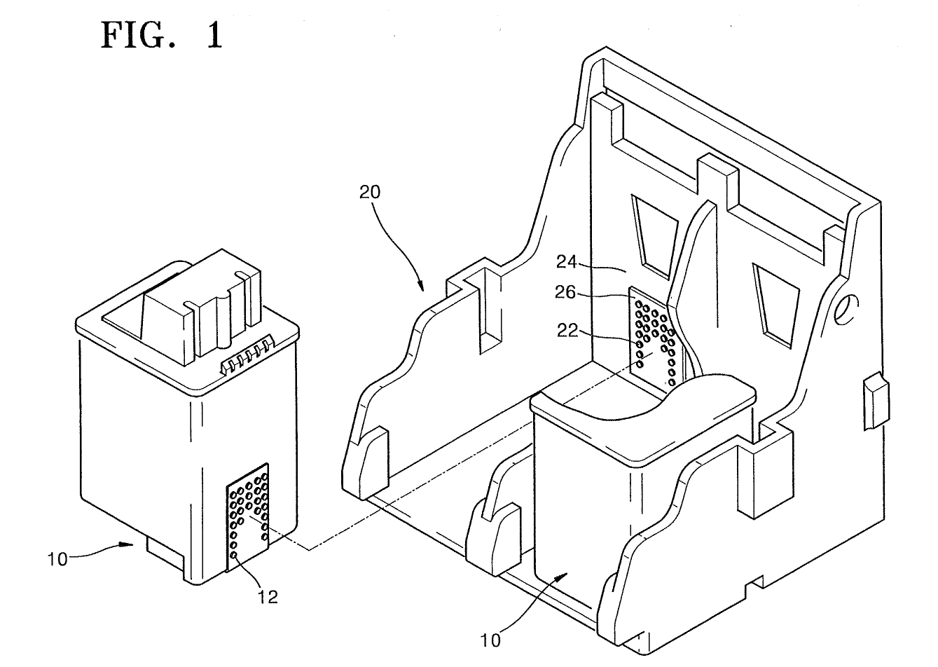

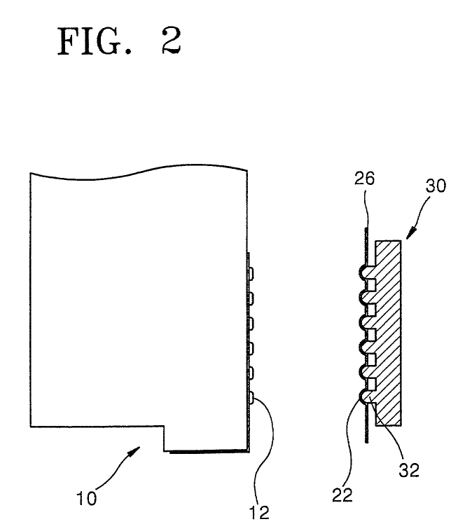

FIGS. 1 and 2 show an ink jet printer having an electrical contact structure. FIG. 1 shows an ink cartridge and a carrier which are separated from each other, and FIG. 2 shows magnified cross-sections of a contact portion of the ink cartridge and a flexible printed circuit board (FPCB) when the ink cartridge is installed in the carrier.

Referring to FIGS. 1 and 2, the ink jet printer includes an ink cartridge 10 having a nozzle portion for spraying ink, a carrier 20 which installs the ink cartridge 10 and horizontally moves, and an FPCB 26 for transmitting an electrical signal between the ink cartridge 10 and the carrier 20.

On one side of the ink cartridge 10 to be installed in the carrier 20 are formed a plurality of contact portions 12 for electrically connecting the ink cartridge to the FPCB 26. The carrier 20 includes a printed circuit board (PCB) 24 for receiving an electrical signal from and transmitting the same to the main board of a computer via a flexible cable (not shown). The PCB 24 is electrically connected to one end of the FPCB 26. The FPCB 26 has a plurality of contact portions 22 that correspond to the contact portions 12 of the ink cartridge 10.

As shown in FIG. 2, the contact portions 22 on the FPCB 26 protrude. Thus, when the ink cartridge 10 is installed on the carrier 20, the contact portions 12 of the ink cartridge 10 contact the contact portions 22 of the FPCB 26. In order for the ink jet printer to perform normal printing, the contact portions 12 of the ink cartridge 10 must apply a contact force to the contact portions 22 of the FPCB 26. In order to achieve this, the FPCB 26 has a rubber elastic member 30 formed on its bottom surface. In this case, the rubber elastic member 30 has a plurality of protrusions 32 corresponding to the protruding contact portions 22 of the FPCB 26.

In the electrical contacting apparatus having such a structure in an ink jet printer, if the heights of some of the plurality of protrusions 32 formed on the rubber elastic member 30 are inconsistent or the contact surface of the rubber elastic member 30 is not flat, a contact force is not applied equally to adjacent protrusions. Thus, contact resistance increases. Consequently, ink is not properly sprayed from the nozzle portion of the ink cartridge.

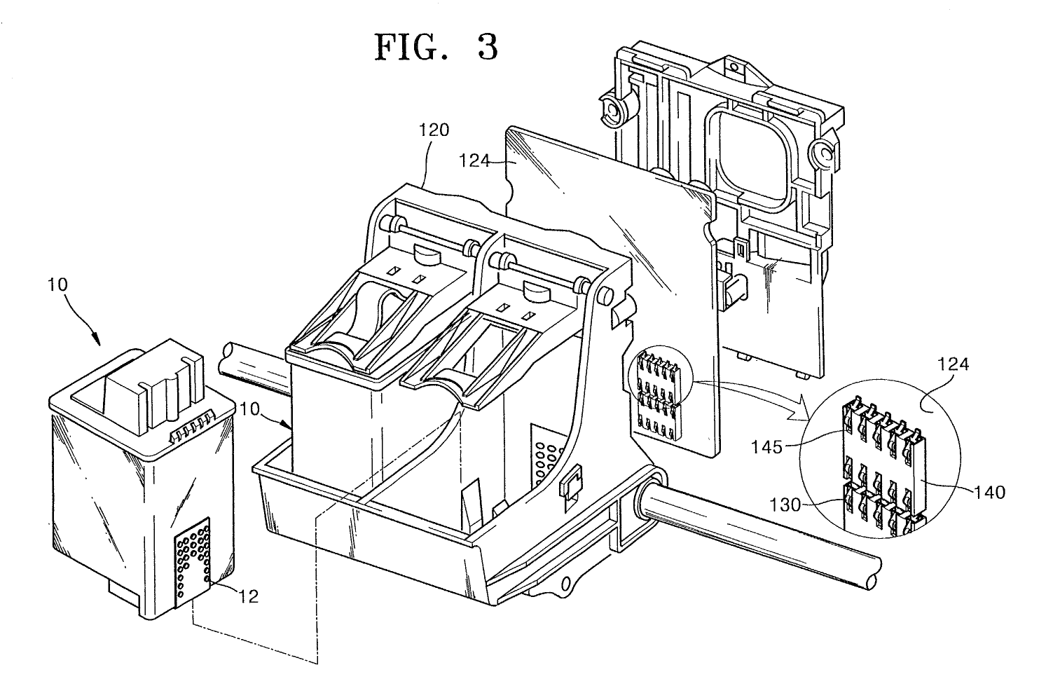

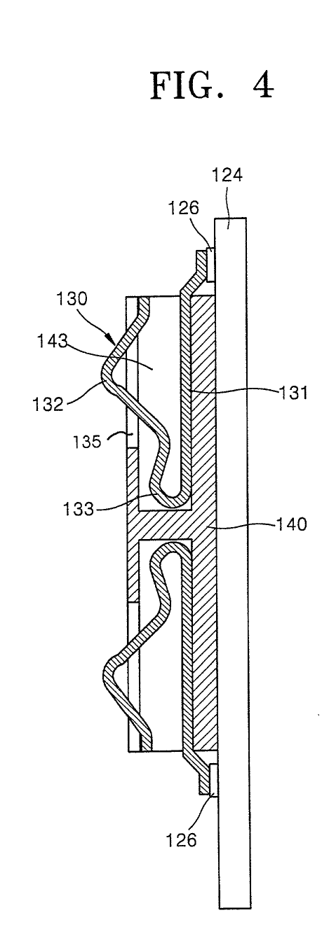

Referring to FIGS. 3 and 4, a carrier 120 in which an ink cartridge 10 is installed to receive an output signal from the main board (not shown) of a computer and perform printing includes a printed circuit board 124 for transmitting and receiving the output signal. A flexible cable (not shown) is attached to one side of the printed circuit board 124 and connected to the main board. The printed circuit board 124 has a plurality of contact portions 126 via which an electrical signal is transmitted. A plurality of contact portions 12 for electrical connection are formed on one side of the ink cartridge 10 as described above.

A contacting apparatus using a plurality of spring elastic members 130 as an apparatus for electrically connecting the contact portions 12 of the ink cartridge 10 to the contact portions 126 of the printed circuit substrate 124 is installed on the printed circuit board 124. The spring elastic member 130 is made up of a contact portion 132, a base 131 and a connection portion 133. The contact portion 132 contacts the contact portions 12 of the ink cartridge 10 when the ink cartridge 10 is mounted on the carrier 120. One end of the base 131 is coupled to a contact portion 126 of the printed circuit board 124. In this embodiment, one end of the base 131 is combined with the contact portion 126 of the printed circuit board 124 by soldering. The connection portion 133 is connected to the contact portion 132 and the base 131, so that it provides an elastic restoration force between the contact portion 132 and the base 131. Preferably, the spring elastic member 130 having such a structure is formed of a material with which a constant contact force can be continuously applied to the contact portions 12 of the ink cartridge 10 even though the contact portion 132 contacts the contact portions 12 of the ink cartridge 10 for a long period of time. In this embodiment, phosphor bronze plated with nickel having a thickness of 0.5 to 20 μm is used, and the surface of the contact portion 132 is further plated with gold having a thickness of 0.1 μm or greater. Preferably, the thickness of nickel is 1.27 μm, and the thickness of gold is 0.3 μm.

In addition, a housing 140 for receiving a plurality of spring elastic members 130 is provided, and maintains the elastic force of the contact portion 132 with respect to the base 131 of the spring elastic member 130. Thus, the housing 140 has a space 143 into which the spring elastic member 130 is received. A window 145 is formed on an opening 135 of the housing 140 at one side of the space 143, the opening facing the contact portions 12 of the ink cartridge 10, so that each of the contact portions 132 of the spring elastic member 130 is exposed to the outside and contacts each of the contact portions 12 of the ink cartridge 10.

In this structure, when the ink cartridge 10 is mounted on the carrier 120, the contact portions 12 of the ink cartridge 10 individually contact the contact portions 132 of the spring elastic member 130 exposed to the outside of the window 145 of the housing 140, so that a constant contact force is applied to each of the contact portions 132 without affecting adjacent contact portions 132.

In an ink jet printer having such a structure, when an output signal from the main board of a computer is transmitted to the printed circuit board 124 of a carrier, it is transmitted to the ink cartridge 10 via the contacting apparatus installed on the printed circuit board 124, whereby printing is performed. That is, the signal which has reached the printed circuit board 124 is transmitted to the base 131 of the spring elastic member 130 combined with each of the contact portions 126 of the printed circuit board 124 and then transmitted to the contact portion 132 via the connection portion 133. Next, the signal is transmitted to each of the contact portions 12 of the ink cartridge 10 which contact the contact portions 132 of the spring elastic member 130. Finally, the signal which has reached the ink cartridge 10 is transmitted to a print head (not shown) on which a nozzle portion is formed, via a flexible printed circuit board (not shown) attached to the ink cartridge 10, whereby printing is performed.

As described above, the electrical contacting apparatus in an ink jet printer according to the present invention includes spring elastic members received in a housing, so that a contact force put on a contact portion of a spring elastic member which contacts an ink cartridge does not affect adjacent contact portions. Consequently, a constant contact force applied to the contact surface of the spring elastic member which contacts the ink cartridge is still maintained for a long period of time. Therefore, the contact resistance at the contact surface of a spring elastic member which contacts the contact portions of an ink cartridge is reduced, thereby improving the quality of printing of ink jet printers.

What is claimed is:

1. An electrical contacting apparatus in an ink jet printer, for contacting the contact portions of an ink cartridge with the contact portions of a printed circuit board installed on a carrier in order to electrically connect the ink cartridge to the carrier on which the ink cartridge is mounted, the apparatus comprising a plurality of spring elastic members corresponding to the contact portions of the ink cartridge, wherein each of the spring elastic members comprises:
a contact portion which contacts a contact portion of the ink cartridge;
a base having one end electrically connected to the printed circuit board; and
a connection portion connected to the contact portion and the base for providing an elastic restoration force between the contact portion and the base.

2. The electrical contacting apparatus in an ink jet printer of claim 1, further comprising a housing for receiving a spring elastic member and maintaining the elastic force of the contact portion of the received spring elastic member with respect to the base of the received spring elastic member.

3. The electrical contacting apparatus in an ink jet printer of claim 2, wherein the housing has a space for receiving the spring elastic member, and a window for exposing the spring elastic member to the outside is formed on an opening of the housing on the side of the space.

4. The electrical contacting apparatus in an ink jet printer of claim 1, wherein one end of the base is electrically connected to the printed circuit board by soldering.

5. The electrical contacting apparatus in an ink jet printer of claim 1, wherein the spring elastic member is formed of phosphor bronze plated with nickel, and the contact portion of the spring elastic member is further plated with gold.

6. The electrical contacting apparatus in an ink jet printer of claim 5, wherein the nickel is formed to a thickness of 0.5 to 20 μm, and the gold is formed to a thickness of 0.1 μm or greater.

7. The electrical contacting apparatus in an ink jet printer of claim 6, wherein the nickel is formed to a thickness of 1.27 μm, and the gold is formed to a thickness of 0.3 μm.

8. An ink-jet printer, comprising:
an ink cartridge comprising a plurality of electrical contacts;
a carrier for mounting said ink cartridge thereon;
a printed circuit board (PCB) disposed on a back side of said carrier;
a housing disposed on said PCB, said housing facing a front side of said carrier, said housing having a plurality of openings facing said front side of said carrier; and
a plurality of spring elastic members disposed in said housing, each of said plurality of spring elastic members being electrically conductive and having a first and a second end, said first end being electrically connected to said PCB and a contacting portion of said elastic member near said second end protruding through a corresponding one of said plurality of openings in said housing and having an elastic force, each one of said plurality of elastic members capable of forming electrical contact at said contacting portion with corresponding ones of said plurality of electrical contacts of said ink cartridge when said ink cartridge is placed on said carrier.

9. The ink-jet printer of claim 8, wherein each one of said plurality of elastic members comprising a connection portion disposed within said housing and disposed between said first end and said contacting portion of said second end of said elastic member providing elastic force to said contacting portion of said elastic member.

10. The ink-jet printer of claim 9, wherein each one of said plurality of elastic members has an equal amount of elastic force as compared to other ones of said plurality of elastic members.

11. The ink-jet printer of claim 9, wherein said connection portion of each of said plurality of elastic members being substantially U-shaped.

12. The ink-jet printer of claim 8, wherein said first end of each of said plurality of elastic members being electrically connected to said PCB by soldering.

13. The ink jet printer of claim 8, wherein each of said plurality of elastic members is made of phosphor bronze plated with nickel, and the contacting portion of the spring elastic member is further plated with gold.

14. The ink jet printer of claim 13, wherein the nickel is formed to a thickness of 0.5 to 20 μm, and the gold is formed to a thickness of 0.1 μm or greater.

15. The an ink jet printer of claim 14, wherein the nickel is formed to a thickness of 1.27 μm, and the gold is formed to a thickness of 0.3 μm.

16. A method for producing a plurality of spring elastic members that provide electrical contact between an ink cartridge and a printed circuit board (PCB) of an ink-jet printer, comprising the steps of:
depositing phosphor bronze plated with nickel on said plurality of spring elastic members;
plating a contacting portion of each of said plurality of spring elastic members with gold;
inserting said plurality of spring elastic members into a housing, wherein said contacting portion of each of said plurality of spring elastic members protrudes through one of a plurality of openings; and
soldering one end of each of said plurality of spring elastic members to said PCB.

17. The method of claim 16, wherein the nickel is formed to a thickness of 0.5 to 20 μm, and the gold is formed to a thickness of 0.1 μm or greater.

18. The method of claim 17, wherein the nickel is formed to a thickness of 1.27 μm, and the gold is formed to a thickness of 0.3 μm.
